(19) United States
(12) Patent Application Publication
(10) Pub. No.: US 2006/0245709 A1
(43) Pub. Date: Nov. 2, 2006

(54) Photonic band gap micro-resonator device and method

(76) Inventor: Avraham Frenkel, Kiriat Bialik (IL)

Correspondence Address: PEARL COHEN ZEDEK, LLP, 1500 BROADWAY 12TH FLOOR, NEW YORK, NY, 10036, US

(21) Appl. No.: 10/565,962

(22) PCT Filed: Jul. 26, 2004
(86) PCT No.: PCT/IL04/00683

§ 371 Date: Jun. 20, 2006

(30) Foreign Application Priority Data
Jul. 31, 2003 (US) 60491246

(51) Int. Cl. G02B 6/10

(52) U.S. Cl. 385/129

(57) ABSTRACT

A photonic band gap micro-resonator device. The device comprises an array of regular elements in a surrounding matrix arranged in a grid. In at least one of a plurality of selected element positions an irregularity is presented in the form of two or more elements replacing a single regular element of the array.

### FIELD OF THE INVENTION

The present invention is related to two-dimensional (2D) and three-dimensional (3D) Photonic Band Gap (PBG) structures and devices, particularly suited for (but not limited to) use as micro-resonators in the Microwaves, Millimeter (MM) Waves, Sub-millimeter Waves, infrared (IR), Visual and ultraviolet (UV) frequency ranges.

### BACKGROUND OF THE INVENTION

A Photonic Band Gap (PBG) structure is based on periodic or quasi-periodic variation of permittivity, permeability or conductivity, such that propagation of electromagnetic waves or photons within the crystal is inhibited at some frequency bands (J. D. Joannopoulos, R. D. Meade and J. N. Winn, “Photonic Crystals”, Princeton University Press, 1995). When irregularities are introduced into the crystal, they could be used to manipulate electromagnetic waves or photons on a distance scale smaller than a wavelength.

Two dimensional Photonic Band Gap structures can be realized in different ways. A first type is a periodic array of dielectric columns of high permittivity. A second type is a periodic array of conducting columns situated within a dielectric background. A third type is a 2D periodic array of holes (or low permittivity material) drilled in a high permittivity dielectric substrate. In all the above cases the PBG structure is in one plane and invariant along the normal to the plane. These structures are easily constructed at microwave and millimeter-wave ranges by direct assembly or by using printed circuit boards with plated or non-plated through-holes. At optical wavelengths, known semiconductor technologies for Silicon, Gallium-Arsenide or Indium-Posphide has been used to demonstrate 2D PBGs.

Three dimensional Photonic Band Gap structures have many possible realizations. The main difficulty in their construction is the generation of accurate three-dimensional periodicity. From the ones that have already been studied we can mention: a 3D crystal of high permittivity dielectric balls, a 3D crystal of non-touching metal balls, a dielectric “wood pile-up” structure with posts of rectangular cross-section, and a 3D periodically perforated dielectric block. The technologies used to build these structures are self-assembly of dielectric or magnetic spheres, inverse-opal generation, and semiconductor technologies that make use of MEMS processing.

In order to generate an irregularity one needs to locally disturb the periodicity of the structure. In 2D PBG structures we take out one column and replace it by a group of new columns (usually with a smaller cross-section). In 3D PBG structures that use spherical “atoms”, we take out one sphere and replace it by a group of new objects (say spheres of smaller radius).

The present invention is based on the smallest irregularity possible: the omission or replacement of a single “atom” in a unit-cell within the crystal. For the purpose of the present invention the term “atom” relates to a single element of a unit-cell in the array of the structure, and crystal relates to the whole structure, in two or three dimensions. Such an irregularity is known also as a PBG micro-cavity (or even nano-cavity) or a PBG micro-resonator. Micro-resonators are the basis for many functional devices such as micro-lasers, modulators, filters, dispersion compensators and more.

The main difficulty of PBG micro-resonators design is the lack of design degrees-of-freedom. Specifically, if one is to dictate the resonance frequency of the micro-resonator, it is very difficult (or sometimes impossible) to get the proper coupling of the resonator to other resonators or to an adjacent waveguide. It is the purpose of the present invention to present novel PBG micro-resonators that have enough degrees of freedom to control the resonance frequency and coupling strength at the same time, while utilizing available micro-electronics technologies. Consequently, it allows controlling parameters such as the central frequency and the shape of a filter, the shape and transfer level of add/drop channel filters, the group velocity and dispersion of coupled-resonators waveguide and more.

Prior art micro-cavities are shown in FIGS. 1a-1f. They include: (in FIG. 1a) omission of an “atom”, (FIG. 1b) replacement by a smaller “atom”, (FIG. 1c) replacement by a larger “atom”, (FIG. 1d) replacement by an atom of a different material, (FIG. 1e) changing the background material of an “atom” and (FIG. 1f) combinations of the above. Augmenting the size and location of “atoms” bordering the irregularity has also been used for fine tuning. Tunable versions have been also proposed where the optical properties of either the central “atoms” or the optical properties of the background material are tuned by an external agent. The typical size of a unit-cell is smaller than 1 wavelength, so atoms have sizes that are a fraction of wavelength. The actual sizes are therefore frequency dependent: in microwaves the unit-cell size is of the order of centimeters, while for IR (infrared) the unit-cell is of the order of microns.

In US 2002/0167984 a nano-cavity laser, modulator and detector arrays are described. All are based on a single irregularity with four different excited modes. The irregularity comprises an absent hole in a 2D hole-based PBG crystal. Thus, there are no internal degrees of freedom to control the resonant frequencies. In US 2002/0172456 a dispersion compensator is described, based on coupled cavity waveguide (CCW). The coupled cavities are void irregularities arranged periodically along a line. Thus, once the PBG crystal is determined, the designer has no additional degrees of freedom to dictate either the resonance frequency or the coupling level between the cavities. In U.S. Pat. No. 6,130,969 a high efficiency channel drop filter is described. The filter is based on a PBG micro-resonators system coupled to two channels. In order for the filter to properly perform, various constrains should be obeyed regarding the resonant frequencies and the coupling levels between the cavities themselves and between the cavities and the channels. To achieve these constraints, three different dielectric materials are used in a single realization of the filter due to the lack of other degrees of freedom. Similarly, US2002/0191905 describes a multi-channel wavelength division multiplexing device, based on selective coupling of energy from a main channel into side channels by means of PBG micro-resonators. Again, the use of three different dielectric materials is necessary to achieve the proper performance, in the absence of inherent degrees of freedom.

It is clear from the above prior-art examples, that the lack of inherent degrees of freedom in PBG micro-resonators, limits the performance of the devices based on these micro-resonators, or leads to prohibitive technical complexities (such as the use of three different dielectric constants at the same layer). It is the purpose of the present invention to introduce PBG micro-resonators with additional degrees of freedom that would enable versatile design procedures for various devices and facilitate the creation of all-optics chips.

### SUMMARY OF THE INVENTION

There is thus provided, in accordance with some preferred embodiments of the present invention, a photonic band gap micro-resonator device, comprising an array of regular elements in a surrounding matrix arranged in a grid, wherein in at least one of a plurality of selected element positions an irregularity is presented in the form of two or more elements replacing a single regular element of the array.

Furthermore, in accordance with some preferred embodiments of the present invention, the array is two-dimensional.

Furthermore, in accordance with some preferred embodiments of the present invention, the array is three-dimensional.

Furthermore, in accordance with some preferred embodiments of the present invention, the irregularity comprises two elements.

Furthermore, in accordance with some preferred embodiments of the present invention, the irregularity comprises four elements.

Furthermore, in accordance with some preferred embodiments of the present invention, the irregularity is in the form of a diamond.

Furthermore, in accordance with some preferred embodiments of the present invention, the irregularity is in the form of a stretched diamond.

Furthermore, in accordance with some preferred embodiments of the present invention, the irregularity comprises elements that are smaller in dimension than the regular elements.

Furthermore, in accordance with some preferred embodiments of the present invention, the irregularity comprises elements that are made from material other than the material from which the regular elements are made.

Furthermore, in accordance with some preferred embodiments of the present invention, the irregularity comprises elements surrounded by a surrounding matrix of different character than the surrounding matrix of the regular elements.

Furthermore, in accordance with some preferred embodiments of the present invention, the irregularity comprises elements that are aligned with axes of the array.

Furthermore, in accordance with some preferred embodiments of the present invention, the irregularity comprises elements that are rotated with respect to axes of the array.

Furthermore, in accordance with some preferred embodiments of the present invention, the irregularity comprises elements that are of a shape different than the shape of a regular element.

Furthermore, in accordance with some preferred embodiments of the present invention, the irregularity is a characterized as a combination of characteristics selected from the group of characteristics including: elements that are smaller in dimension than the regular elements, elements that are made from material other than the material from which the regular elements are made, elements surrounded by a surrounding matrix of different character than the surrounding matrix of the regular elements, elements that are aligned with the regular elements, elements that are rotated with respect to the regular elements and elements that are of a shape different than the shape of a regular element.

Furthermore, in accordance with some preferred embodiments of the present invention, the device further comprises two channels for traversing electromagnetic radiation within the array, with the irregularity positioned between the channels, producing a channel drop filter.

Furthermore, in accordance with some preferred embodiments of the present invention, the channels are optical channels.

Furthermore, in accordance with some preferred embodiments of the present invention, the channels are substantially parallel.

Furthermore, in accordance with some preferred embodiments of the present invention, a plurality of irregularities is provided in the array in the form of a periodic line of that serves as a dispersive waveguide.

Furthermore, in accordance with some preferred embodiments of the present invention, the irregularity comprises two elements in the form of two parts of a split cylinder kept at a predetermined distance.

Furthermore, in accordance with some preferred embodiments of the present invention, the predetermined distance is adjustable.

Furthermore, in accordance with some preferred embodiments of the present invention, there is provided a method for photonic band gap micro-resonance comprising:

providing an array of regular elements regular elements in a surrounding matrix arranged in a grid, wherein in at least one of a plurality of selected element positions an irregularity is presented in the form of two or more elements replacing a single regular element of the array; irradiating electromagnetic radiation through to the irregularity causing a resonance effect.

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1a illustrates a photonic band gap (PBG) array with an irregularity characterized by the omission of a single element (“atom”) of the array.

FIG. 1b illustrates a photonic band gap (PBG) array with an irregularity characterized by the replacement of an atom of the array by an atom of smaller dimension.

FIG. 1c illustrates a photonic band gap (PBG) array with an irregularity characterized by the replacement of a single atom by a larger atom.

FIG. 1d illustrates a photonic band gap (PBG) array with an irregularity characterized by the replacement of a single atom by an atom of a different material.

FIG. 1e illustrates a photonic band gap (PBG) array with an irregularity characterized by changing the background material of an atom.

FIG. 1f illustrates a photonic band gap (PBG) array which is a combination of the above-mentioned irregularities.

FIG. 2a illustrates a PBG crystal, in accordance with a preferred embodiment of the present invention, where a single atom is replaced by an irregularity consisting of two smaller atoms in an aligned orientation (with respect to the crystal axes where they reside).

FIG. 2b illustrates a PBG crystal, in accordance with a preferred embodiment of the present invention, where a single atom is replaced by an irregularity consisting of two smaller atoms in a rotated orientation (with respect to the crystal axes where they reside).

FIG. 2c illustrates a PBG crystal, in accordance with a preferred embodiment of the present invention, where a single atom is replaced by a quadra-atom irregularity.

FIG. 2d illustrates a PBG crystal, in accordance with a preferred embodiment of the present invention, where a single atom is replaced by an irregularity consisting of two smaller atoms of different material.

FIG. 2e illustrates a PBG crystal, in accordance with a preferred embodiment of the present invention, where a single atom is replaced by an irregularity consisting of two smaller atoms and the background material of the unit-cell is changed as well.

FIG. 2f illustrates a PBG crystal, in accordance with a preferred embodiment of the present invention, where a single atom is replaced by an irregularity consisting of a combination of the previous irregularities.

FIG. 3 illustrates an electric field map of a monopole mode of a dual-atom micro-resonator (like in FIG. 2a). The PBG is made of dielectric posts (dielectric constant=11.9) with radius “r” and square lattice constant “a” (r/a=0.2).

FIG. 4 illustrates an electric field map of a dipole mode of the dual-atom micro-resonator.

FIG. 5 shows graphically the dependence of the normalized resonance frequencies (fa/c) of both the monopole and dipole modes of the dual-atom micro-resonator (r′/a=0.1), as a function of the normalized separation d/a between the atoms.

FIG. 6 shows graphically the dependence of the normalized resonance frequencies (fa/c) of both the monopole and dipole modes of the dual-atom micro-resonator (d/a=0.8), as a function of the normalized radius r′/a of the irregularity atoms.

FIG. 7 illustrates two coupled micro-resonators with rotated dual-atom irregularities. The micro resonators are separated by just two ordinary columns of the PBG crystal (d/a=0.8, r/a=0.2, r′/a=0.1) FIG. 8 illustrates graphically the normalized resonance frequency split (Δf/f_{c}) of the coupled resonators, as a function of the angle of rotation of one of the dual-atom irregularity.

FIG. 9a illustrates graphically the monopole mode of the quadra-atom micro-resonator (normalized resonance frequency fa/c=0.321).

FIG. 9b illustrates the y-dipole mode of the quadra-atom micro-resonator (of FIG. 2c, normalized resonance frequency is fa/c=0.394).

FIG. 9c illustrates the x-dipole mode of the quadra-atom micro-resonator (normalized resonance frequency is fa/c=0.394).

FIG. 9d illustrates the quadra-pole mode of the quadra-atom micro-resonator (normalized resonance frequency is fa/c=0.439).

FIG. 10 illustrates the structure of a channel drop filter, with two channels (port1 to port3, and port2 to port4) and an augmented quadra-atom micro-resonator, in accordance with a preferred embodiment of the present invention.

FIG. 11 illustrates graphically the performance of a backward channel drop filter, displaying full coupling from port1 to port2 at the resonance frequency.

FIG. 12 illustrates the structure of a periodic coupled-cavity-waveguide (CCW), with a unit cell made of one regular atom and one micro-resonator having two cylindrical halves separated by a distance s.

FIG. 13 illustrates graphically the dispersion curves of a dipole mode of CCW of FIG. 12, for different separations s/a of the two cylindrical halves.

FIG. 14 illustrates the structure of a periodic coupled-cavity-waveguide (CCW), with a unit cell made of one regular atom and two micro-resonators—one with s₁/a=0.09 and the other with s₂/a=0.12.

FIG. 15 illustrates graphically the dispersion curve of both the dipole mode and the monopole mode of the CCW of FIG. 14.

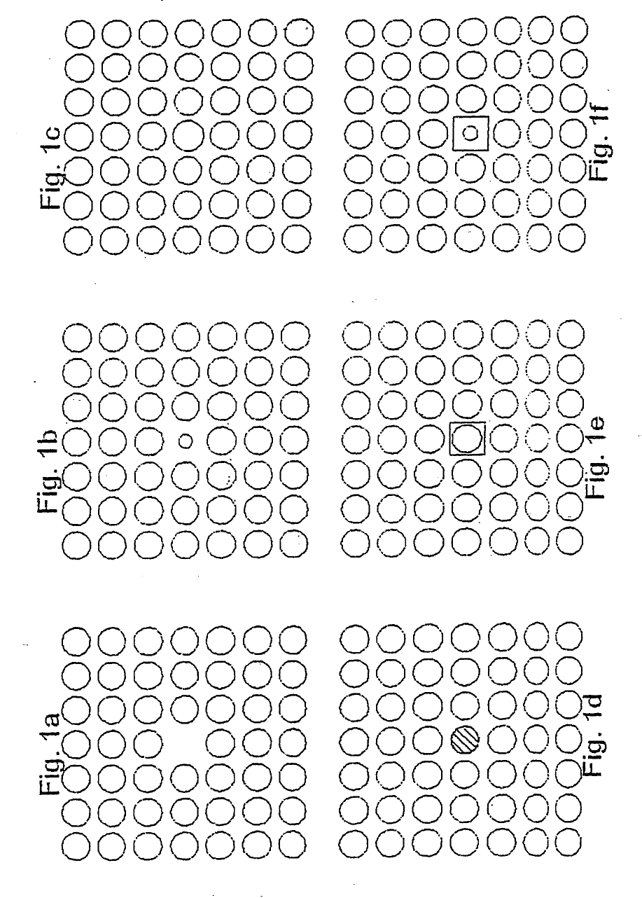

### DETAILED DESCRIPTION OF PREFERRED EMBODIMENTS

The present invention aims at providing a high Q micro-resonator with new inherent degrees of freedom, and devices using these micro-resonators. The micro-resonator of the present invention employs a novel irregularity type in a Photonic Band Gap (PBG) crystal such that different properties as the resonance frequency and coupling to adjacent channels could be independently dictated. This is accomplished by filling a void irregularity in the PBG crystal with several augmented elements that may vary in number, shape, size, arrangement and material. Applications to a quadra-mode micro-resonator are disclosed, a channel-drop filter and two coupled cavity waveguides with positive and negative group velocities. Tunable or controlled versions of the proposed micro-resonators allow the design of active devices as micro-lasers, sensors, modulators, switches and routers.

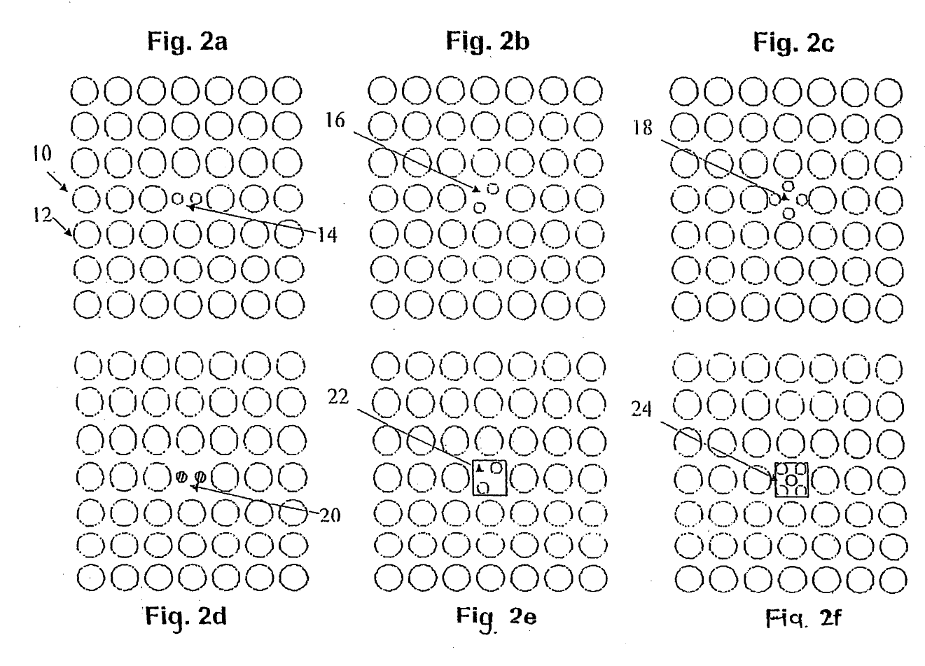

A new type of micro-cavity in a periodic or quasi-periodic 2D or 3D Photonic Band Gap structures is proposed, where an atom of the grid is replaced by two or more auxiliary atoms of the same or another size, of the same or another material, of the same or another shape, with or without changing the background material within the irregularity volume, with or without tunability. Reference is made to FIG. 2a, illustrating a PBG crystal, denoted by numeral 10, in accordance with a preferred embodiment of the present invention, where a single atom 12 of the crystal is replaced by an irregularity 14 consisting of two smaller atoms in an aligned orientation (with respect to the crystal axes where they reside).

FIG. 2b illustrates a PBG crystal, in accordance with a preferred embodiment of the present invention, where a single atom is replaced by an irregularity 16 consisting of two smaller atoms in a rotated orientation (with respect to the crystal axes where they reside).

FIG. 2c illustrates a PBG crystal, in accordance with a preferred embodiment of the present invention, where a single atom is replaced by a quadra-atom irregularity 18.

FIG. 2d illustrates a PBG crystal, in accordance with a preferred embodiment of the present invention, where a single atom is replaced by an irregularity 20 consisting of two smaller atoms of different material.

FIG. 2e illustrates a PBG crystal, in accordance with a preferred embodiment of the present invention, where a single atom is replaced by an irregularity 22 consisting of two small atoms locally surrounded by a different type of surrounding matrix (different from the rest of the crystal).

FIG. 2f illustrates a PBG crystal, in accordance with a preferred embodiment of the present invention, where a single atom is replaced by an irregularity 24 consisting of a combination of the previous irregularities. Some uses of the new micro-cavities for several applications are demonstrated herein.

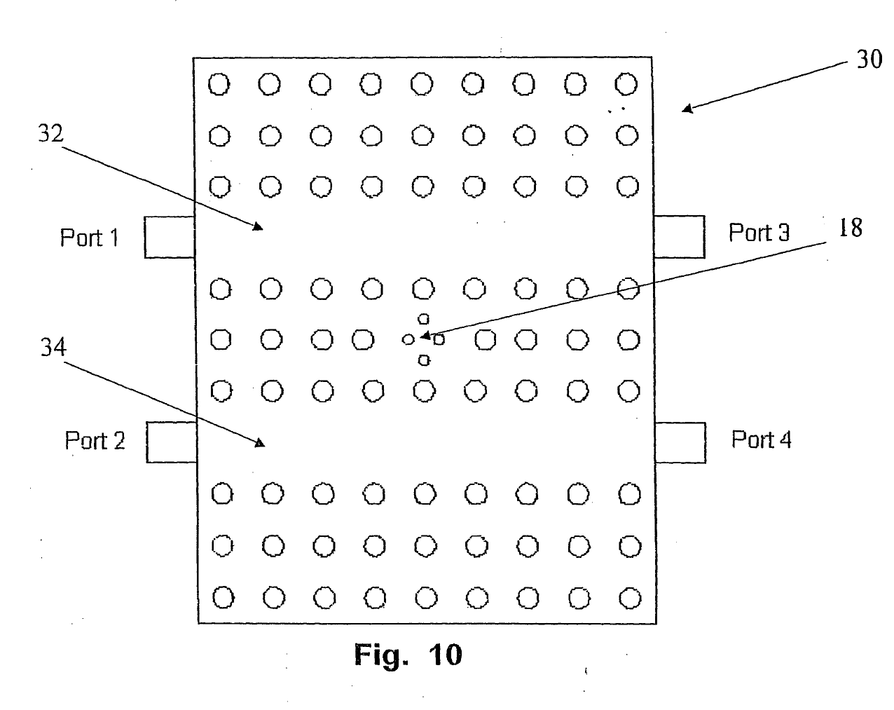

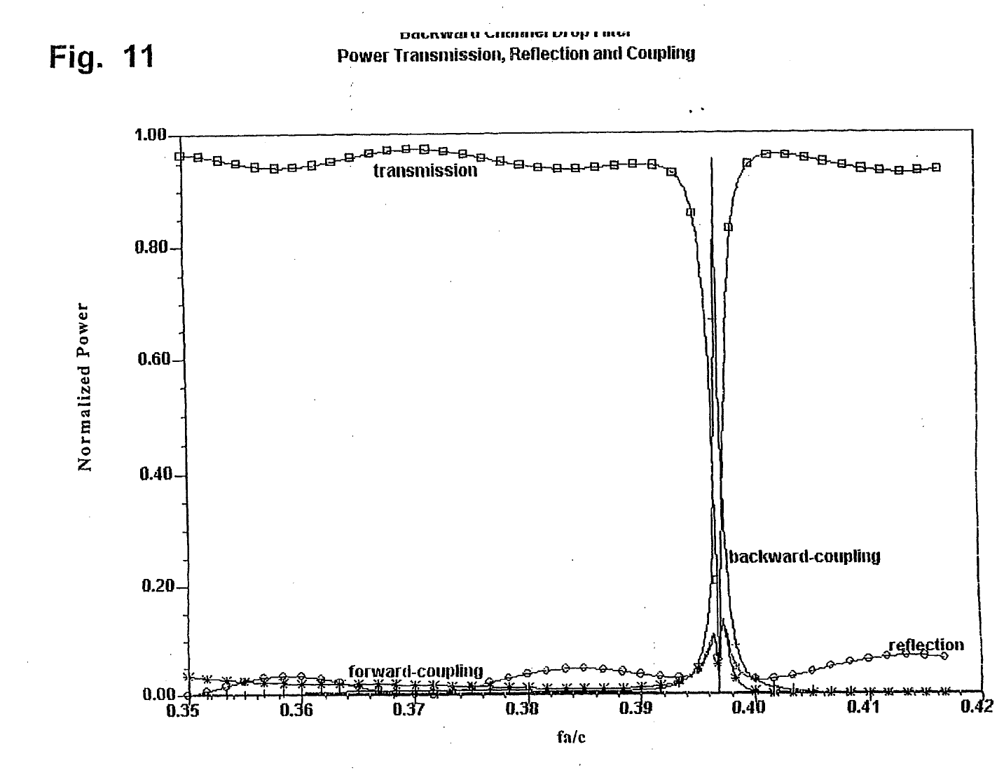

In one embodiment of a device incorporating micro-resonators, in accordance with the present invention a channel drop filter is shown (FIG. 10) that selectively drops a frequency slice from the main channel to a secondary channel.

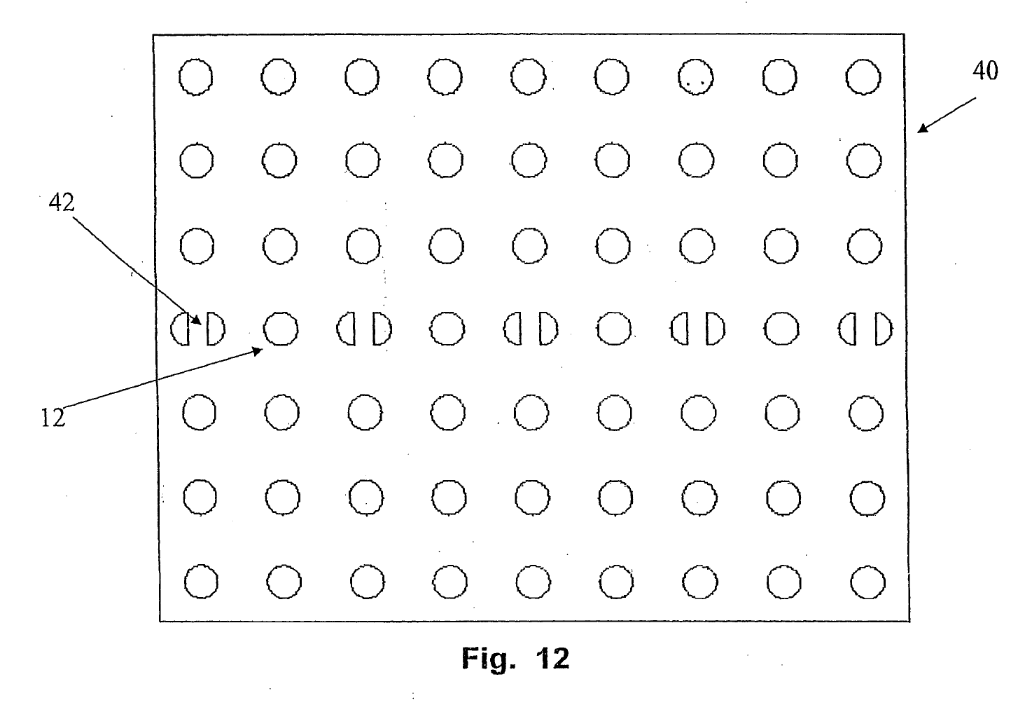

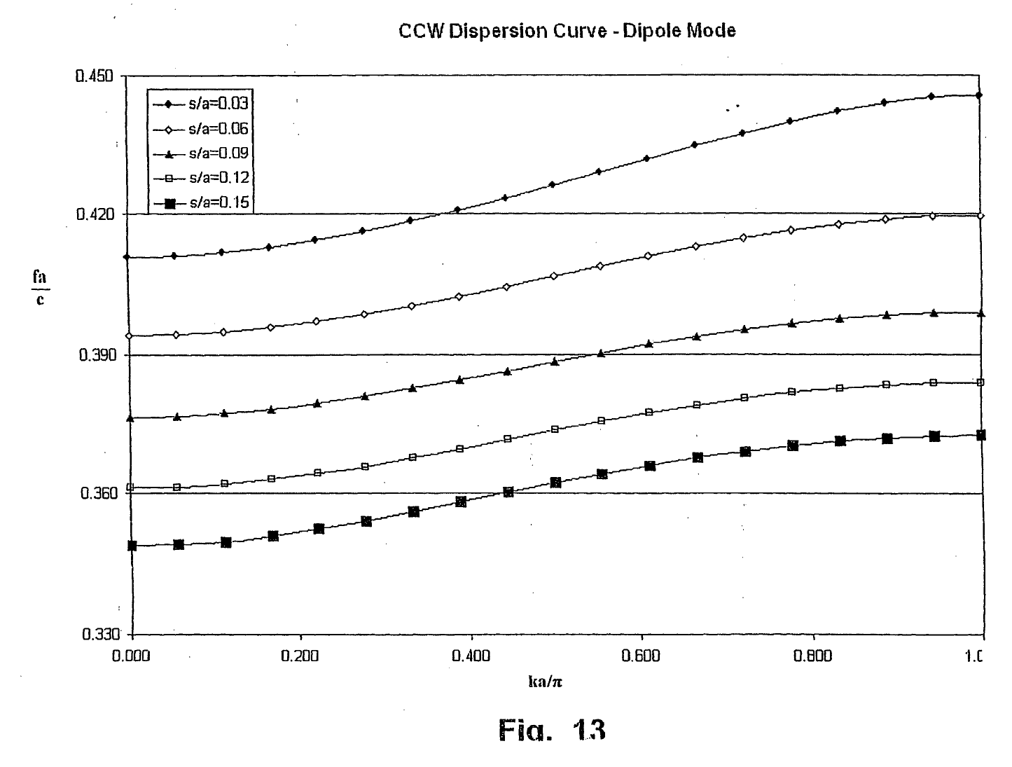

In another preferred embodiment of the present invention, a periodic line of coupled micro-cavities (FIG. 12) is provided that serves as a dispersive waveguide with superior performance and tuning capabilities.

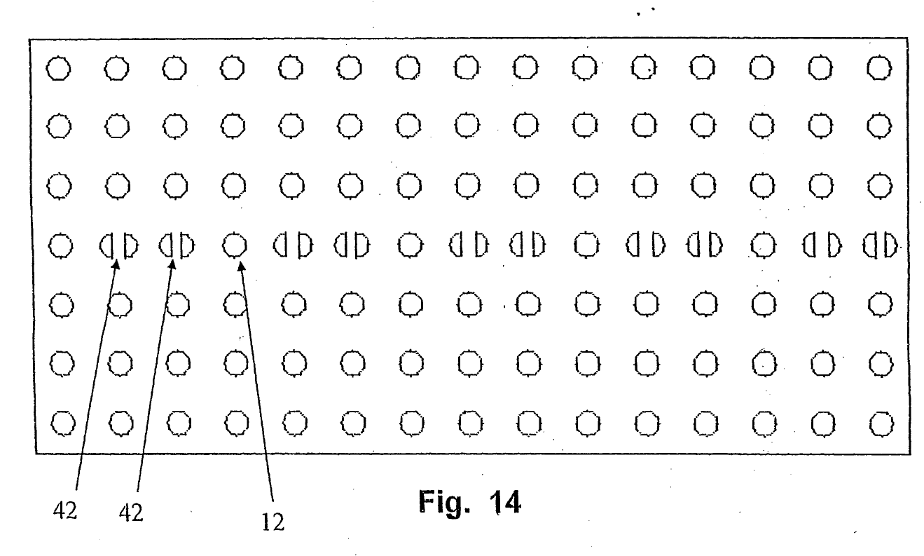

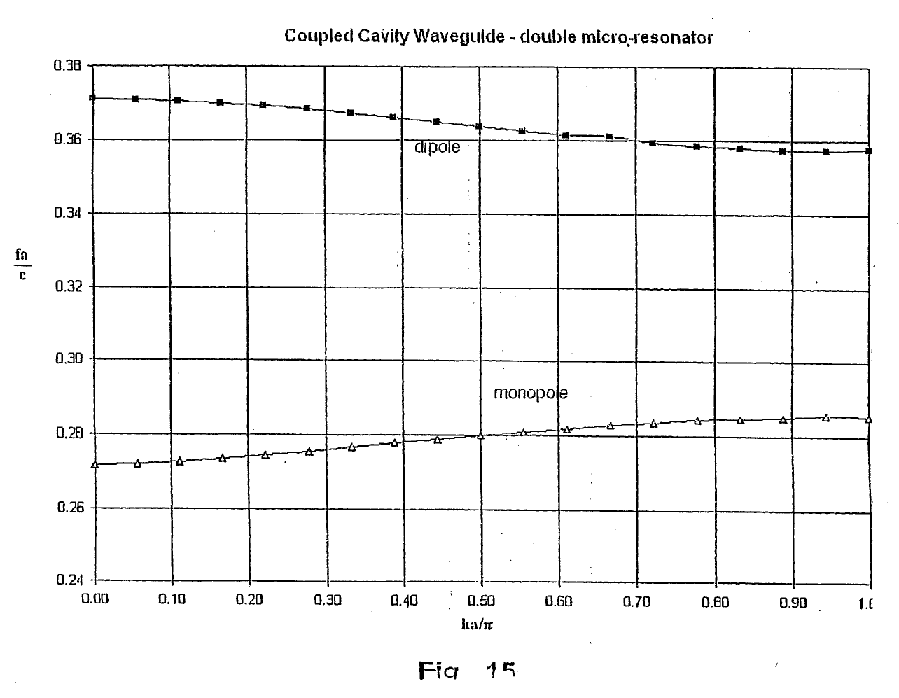

In yet another preferred embodiment of the present invention, another periodic line of coupled micro-cavities (FIG. 14) that displays a negative group-velocity is provided.

The proposed micro-cavity arrangement of the present invention brings new capabilities and performances not attainable by prior-art:

The number of modes of the micro-cavity is controlled mainly by the number of the auxiliary atoms of the irregularity and not only by the size of the irregularity.

The frequency of a specific mode could be tuned by varying the size or location of the auxiliary atoms, without resorting to changes of materials. The coupling level between two micro-cavities or between a micro-cavity and a waveguide could be tuned, while maintaining the resonance frequency.

Degenerate modes are easily generated and their symmetry controlled. Also, breaking of the degeneracy—if necessary—can be carried out in a controlled way by using a non-symmetric group of auxiliary atoms.

The field-distributions of the modes, and sometimes also their polarization, depend on the relative rotation of the group of auxiliary atoms relative to the PBG lattice. This gives an additional degree of freedom to control the irregularity properties.

If the frequency of certain mode is tuned to the center of the gap, this micro-cavity mode would be super-localized, i.e. the mode field-distribution extends only to the closest atoms in the crystal. Super-Localized modes have very high Q-value and small volume, extremely important properties for micro-lasers and filters.

High order super-localized modes demonstrate strong sign variations or polarization variations inside the irregularity. In 2D PBG crystals this is a major advantage, because it naturally reduces the radiation losses in out-of-plane directions.

Dispersive Coupled-Cavity-Waveguides (CCWs) could be designed to have a variety of dispersion curves and group velocities. This is done by controlling independently the resonance frequencies and coupling strength between the cavities. The design CCWs with negative group velocity is possible.

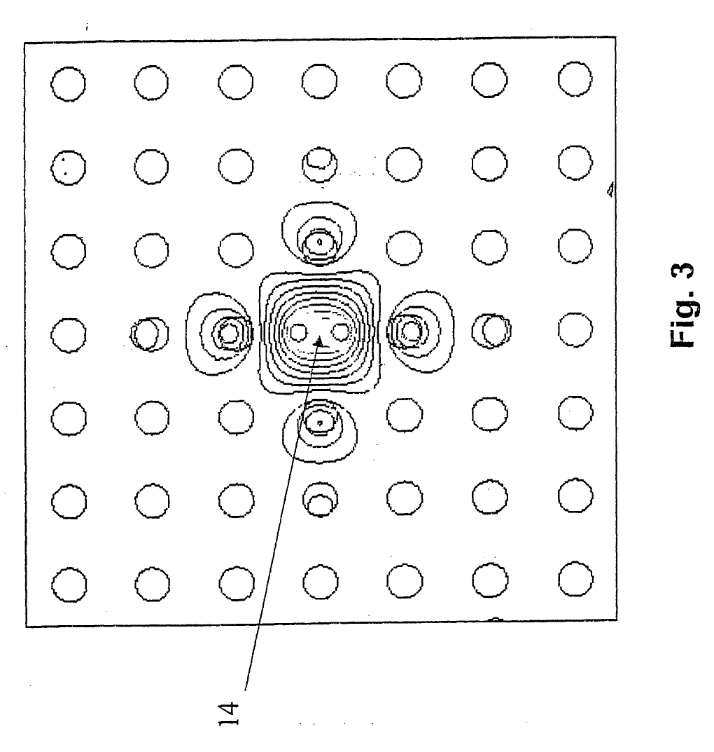

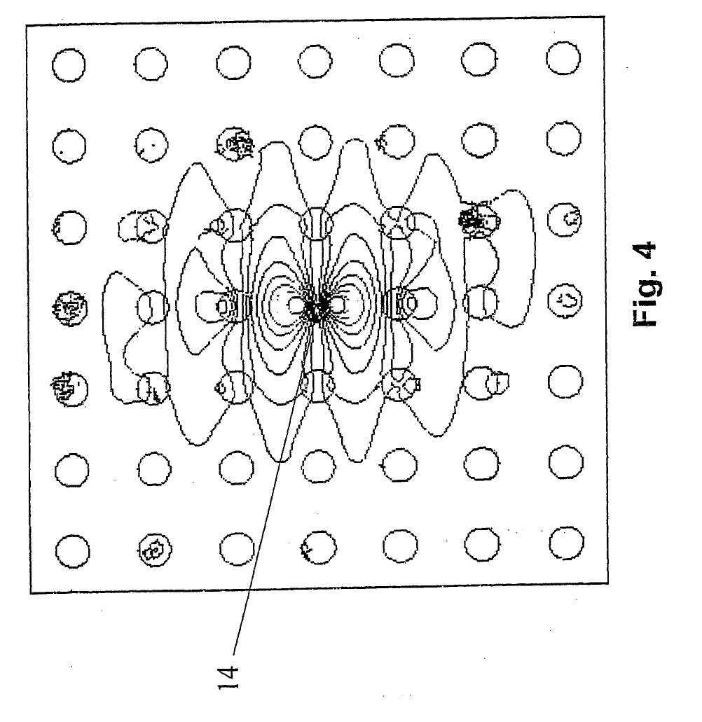

The simplest new irregularity type is the one that includes two auxiliary atoms (see FIGS. 2a, 2b). As long as the auxiliary atoms are smaller than the lattice atoms, this micro-cavity can have two modes. Specifically, if the two auxiliary atoms are identical and symmetrically located relative to the irregularity center, the two modes are a symmetric monopole mode (see 14 in FIG. 3) and an anti-symmetric dipole mode (see 14 in FIG. 4).

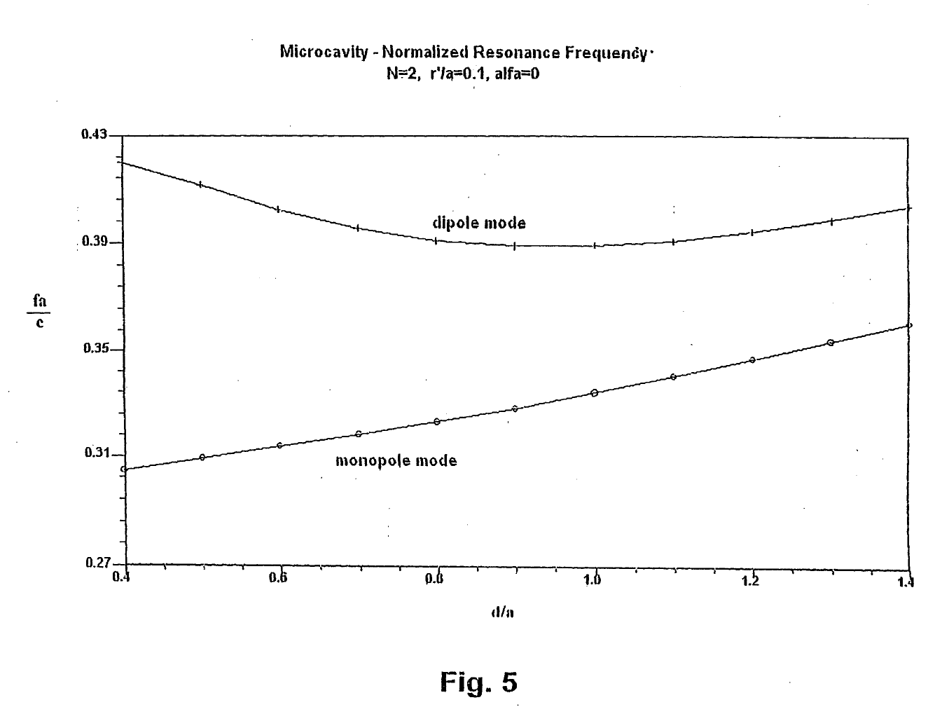

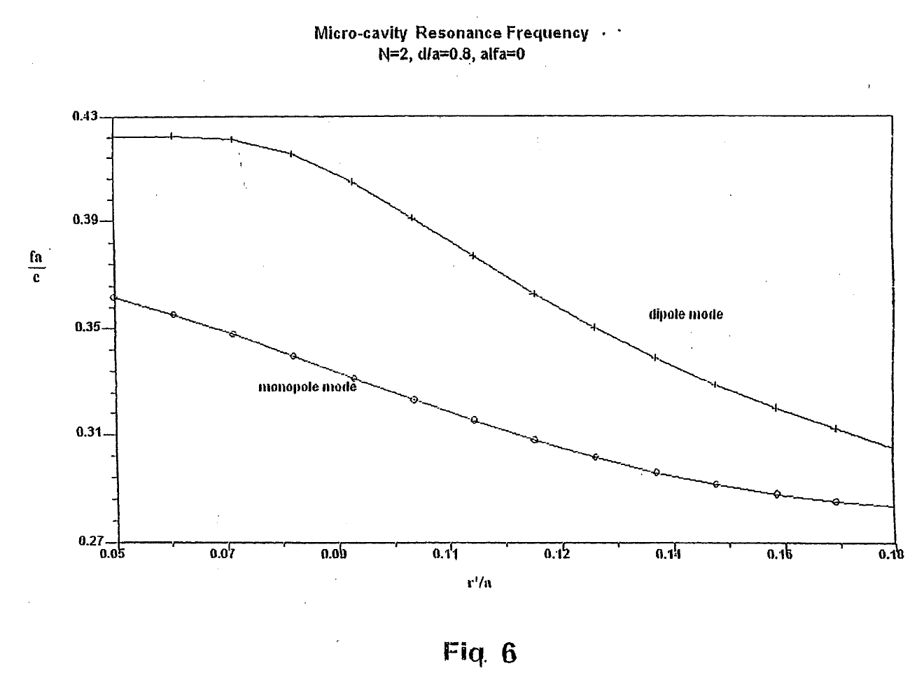

To demonstrate the control the resonance frequency, a specific example of a “rod” type PBG is presented herein, with a square lattice of distance a, the radius r of an atom of the lattice exhibiting the ration r/a=0.2, and dielectric constant 11.9. This 2D PBG has a gap for normalized frequencies from fa/c=0.27 up to fa/c=0.42, where f is the frequency, a is the unit-cell's lateral dimension and c is the velocity of light. The dependence of the resonance frequencies on the distance between the auxiliary atoms (for fixed radius r′/a=0.1, where r′ is the radius of the auxiliary atom) is presented in FIG. 5. It can be appreciated that the dipole-mode exists closed to the upper edge, and thus is not well localized. The dependence of resonance frequencies on the radius of the auxiliary atoms r′/a (for a fixed distance d/a=0.8) is presented in FIG. 6. One can observe that for large enough r′, the resonance frequency of the dipole mode is lowered and it is also well inside the gap.

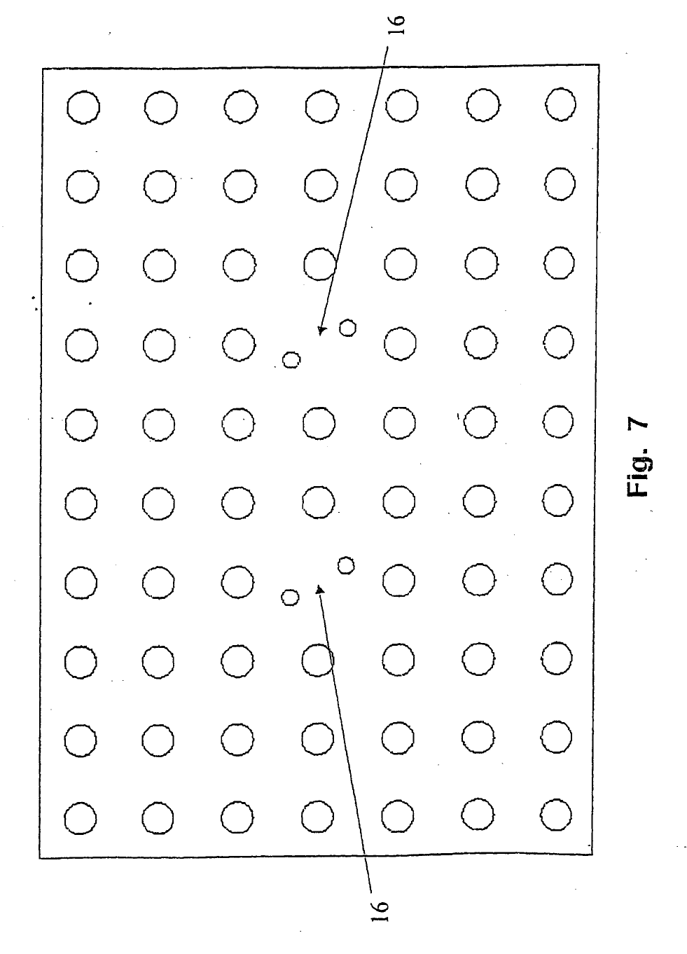

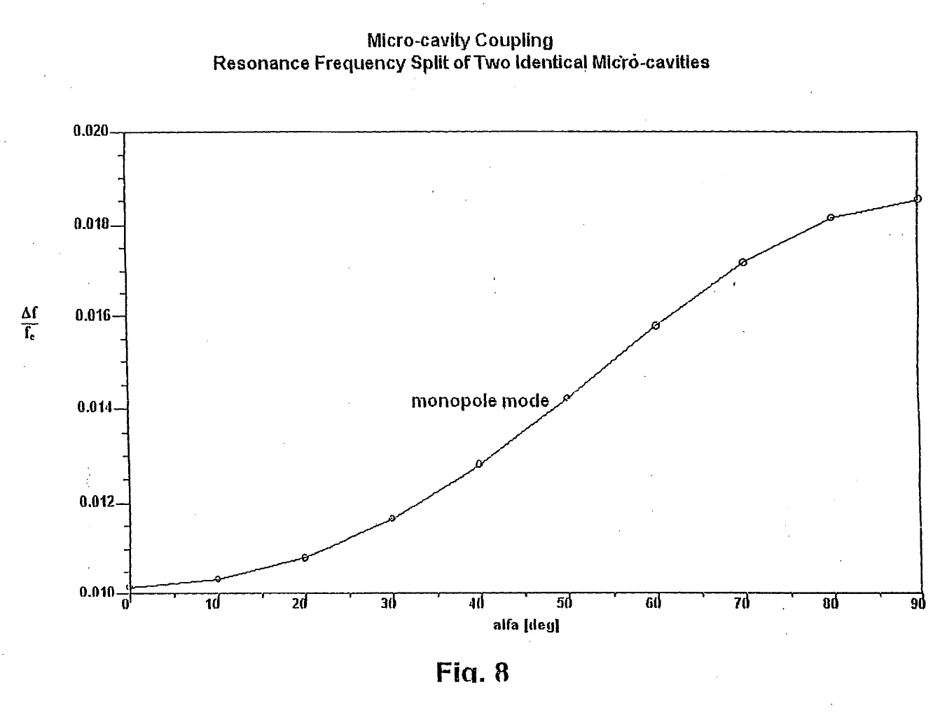

The control of the coupling between two micro-resonators is also demonstrated herein (see FIG. 7). We fix d/a=0.8 and r′/a=0.1, where d is the internal distance between adjacent atoms of the irregularity, but rotate both irregularities 16 relative to the lattice of the crystal. The range of angles is from 0 degrees (collinear) to 90 degrees (parallel). In this way the basic resonance frequencies of both micro-resonators is the same, however the coupling between them splits each of the modes into a doublet. All in all we have 4 different resonance frequencies. The measure of the coupling is the ratio between the doublet-split and the doublet-average frequency (Δf/f_{c}). We observe noticeable coupling control of factor 2 (see FIG. 8). This coupling control is an essential part of any multi-resonator system design.

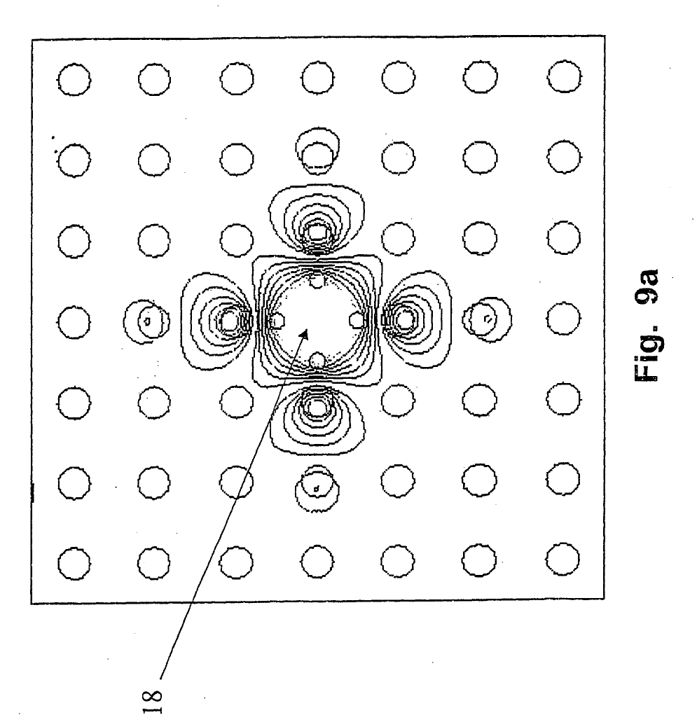

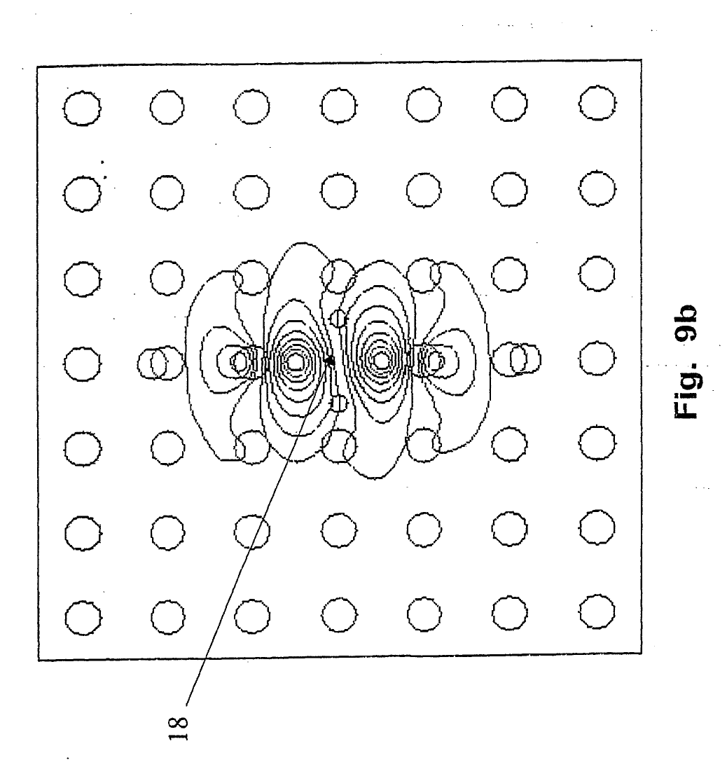

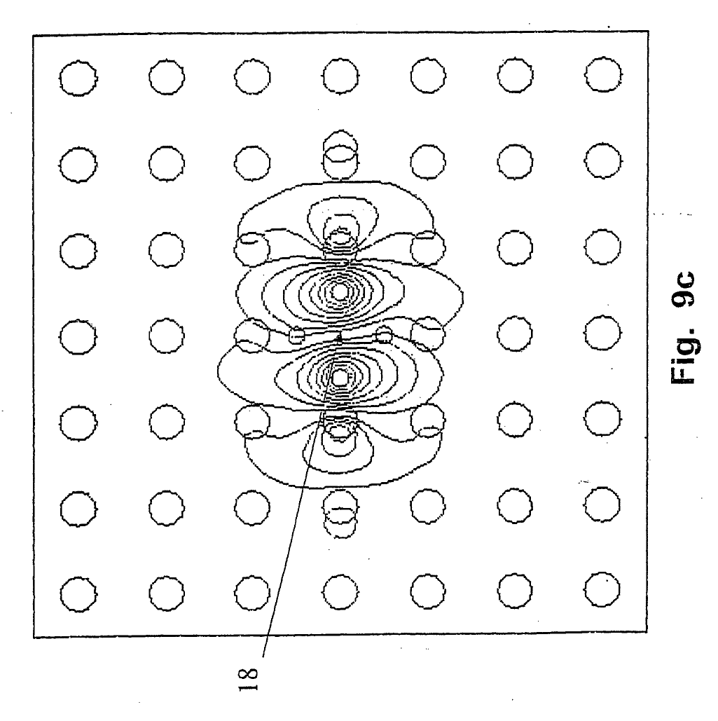

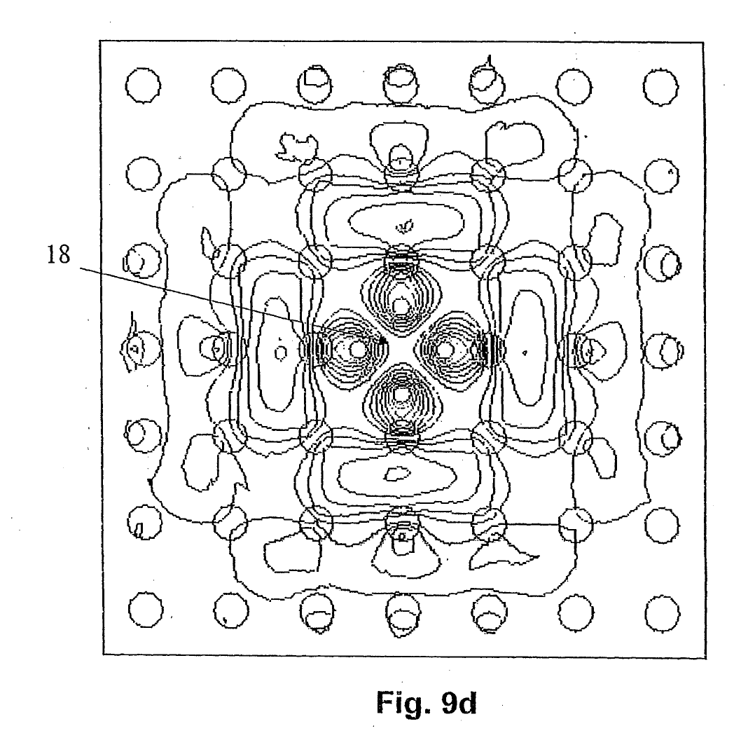

We now demonstrate an application of a Backward Drop Channel Filter. It is well known that this type of filters needs a resonator with two degenerate modes, and has been already demonstrated by using a micro-ring resonator. We chose for the task an irregularity with four auxiliary “atoms”. The isolated fully symmetric micro-resonator has four modes (see FIGS. 9a-9d): a monopole mode (18 in FIG. 9a), two degenerate dipole modes (18 in FIG. 9b and in FIG. 9c) and a quadra-pole mode (18 in FIG. 9d) at normalized frequencies 0.321, 0.394 and 0.439 respectively. The two degenerate dipole modes have odd-even and even-odd symmetries that could be exploited for backward channel dropping. When inserted between two waveguides (see 32 and 34 in FIG. 10), the two degenerate modes split because the resonator is not isolated anymore. In order to properly design the filter we need to tune the two frequencies to be identical again, and also have close coupling levels to the waveguide. This has been accomplished by stretching the irregularity 18 into a diamond shape, and augmenting the location of two neighboring “atoms” of the lattice. The final performance of the Channel Drop Filter is shown in FIG. 11. We emphasize that this has been simulated using a single material (ε=11.9) and the filter can be manufactured using standard micro-electronics technologies.

A Coupled-Cavity-Waveguide (CCW) can be used as a delay-line or as a dispersion compensator. It is built by chaining micro-cavities periodically along a line. The wave is hopping from one resonator to another with group velocity that strongly depends on frequency. We use our novel micro-cavities to design a CCW 40, and demonstrate that the dispersion-curve (k(ω)) can be easily controlled. We use an irregularity of a split cylinder 42 (see FIG. 12), and vary the distance between the two halves (separation=2s). This special irregularity choice has the property that for s=0 the waveguide is blocked completely, because it becomes an ideal PBG. As we enlarge the separation above s/a=0.06, the dipole-mode enters from above the Photonic Gap (FIG. 13), and the frequency band for which the CCW is open shifts down with similar dispersion curves. The group velocity v_{g}=dω/dk can be derived from FIG. 13 by evaluating the derivative, and it has the typical bell shape with v_{g}=0 at ka/π=0, 1 and maximum at ka/π=0.5. Additional control on the operational frequency band and shape of the dispersion can be achieved by changing the radius of the half-cylinders, and by controlling the rotation angle relative to the crystal axes.

We present an additional design (see FIG. 14) where each unit-cell includes a pair of micro-resonators and one regular atom. By choosing different spacing for each of the resonators (s₁/a=0.12 and s₂/a=0.09) we get a CCW with dipole type resonance (for both resonators) that has extraordinary negative group velocity (see FIG. 15). We also have, close to the lower edge of the band, a CCW with a monopole type resonance (for both resonators) and ordinary positive group velocity. Waveguides with negative group velocity have applications in pulse compression and delay control of optical signals.

All the above micro-resonators and devices could become tunable or actively controlled devices. There are different methods to achieve active control:

I) Use of ferro-electric materials within the micro-resonator design (for example, the defects shown in FIG. 2d, 2e, 2f or the surrounding matrix of the defects), and control of the dielectric constants of the ferro-electric elements by an external DC electric field.

II) Use of light sensitive materials within the micro-resonator design, and control of the refraction index by external illumination at wavelengths for which the PBG is penetrable.

III) Use of ferrites or other permeability controlled materials within the micro-resonator design, and control of the permeability of the ferrite elements by an external magnetic field.

IV) Use of magnetic materials within the micro-resonator design, and control of the location of the atoms inside the irregularity by an external magnetic field.

V) Use of active materials inside the micro-resonator design (FIG. 2e, 2f) and creation of micro-lasers and sensors.

The various methods of externally controlling the structure or the material properties of the micro-resonators as described above, allow designing of many additional devices such as sources, sensors, switches, modulators and routers.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A photonic band gap micro-resonator device, comprising an array of regular elements in a surrounding matrix arranged in a grid, wherein in at least one of a plurality of selected element positions an irregularity is presented in the form of two or more elements replacing a single regular element of the array.

2. The device of claim 1, wherein the array is two-dimensional.

3. The device of claim 1, wherein the array is three-dimensional.

4. The device of claim 1, wherein the irregularity comprises two elements.

5. The device of claim 1, wherein the irregularity comprises four elements.

6. The device of claim 5, wherein the irregularity is in the form of a diamond.

7. The device of claim 6, wherein the irregularity is in the form of a stretched diamond.

8. The device of claim 1, wherein the irregularity comprises elements that are smaller in dimension than the regular elements.

9. The device of claim 1, wherein the irregularity comprises elements that are made from material other than the material from which the regular elements are made.

10. The device of claim 1, wherein the irregularity comprises elements surrounded by a surrounding matrix of different character than the surrounding matrix of the regular elements.

11. The device of claim 1, wherein the irregularity comprises elements that are aligned with axes of the array.

12. The device of claim 1, wherein the irregularity comprises elements that are rotated with respect to axes of the array.

13. The device of claim 1, wherein the irregularity comprises elements that are of a shape different than the shape of a regular element.

14. The device of claim 1, wherein the irregularity is a characterized as a combination of characteristics selected from the group of characteristics including: elements that are smaller in dimension than the regular elements, elements that are made from material other than the material from which the regular elements are made, elements surrounded by a surrounding matrix of different character than the surrounding matrix of the regular elements, elements that are aligned with the regular elements, elements that are rotated with respect to the regular elements and elements that are of a shape different than the shape of a regular element.

15. The device of claim 1, further comprising two channels for traversing electromagnetic radiation within the array, with the irregularity positioned between the channels, producing a channel drop filter.

16. The device of claim 15, wherein the channels are optical channels.

17. The device of claim 15, wherein the channels are substantially parallel.

18. The device of claim 1, wherein a plurality of irregularities is provided in the array in the form of a periodic line of that serves as a dispersive waveguide.

19. The device of claim 18, wherein the irregularity comprises two elements in the form of two parts of a split cylinder kept at a predetermined distance.

20. The device of claim 19, wherein the predetermined distance is adjustable.

21. A method for photonic band gap micro-resonance comprising:
providing an array of regular elements regular elements in a surrounding matrix arranged in a grid, wherein in at least one of a plurality of selected element positions an irregularity is presented in the form of two or more elements replacing a single regular element of the array; irradiating electromagnetic radiation through to the irregularity causing a resonance effect.

22. The method of claim 21, wherein the array is two-dimensional.

23. The method of claim 21, wherein the array is three-dimensional.

24. The method of claim 21, wherein the irregularity comprises two elements.

25. The method of claim 21, wherein the irregularity comprises four elements.

26. The method of claim 21, wherein the irregularity is in the form of a diamond.

27. The method of claim 26, wherein the irregularity is in the form of a stretched diamond.

28. The method of claim 21, wherein the irregularity is resonated as a monopole.

29. The method of claim 21, wherein the irregularity is resonated as a dipole

30. The method of claim 21, wherein the irregularity is resonated as a quadra-pole.

31. The method of claim 21, wherein the irregularity comprises elements that are smaller in dimension than the regular elements.

32. The method of claim 21, wherein the irregularity comprises elements that are made from material other than the material from which the regular elements are made.

33. The method of claim 21, wherein the irregularity comprises elements surrounded by a surrounding matrix of different character than the surrounding matrix of the regular elements.

34. The method of claim 21, wherein the irregularity comprises elements that are aligned with the regular elements.

35. The method of claim 21, wherein the irregularity comprises elements that are rotated with respect to the regular elements.

36. The method of claim 21, wherein the irregularity comprises elements that are of a shape different than the shape of a regular element.

37. The method of claim 21, wherein the irregularity is a characterized as a combination of characteristics selected from the group of characteristics including: elements that are smaller in dimension than the regular elements, elements that are made from material other than the material from which the regular elements are made, elements surrounded by a surrounding matrix of different character than the surrounding matrix of the regular elements, elements that are aligned with the regular elements, elements that are rotated with respect to the regular elements and elements that are of a shape different than the shape of a regular element.

38. The method of claim 21, further comprising two channels for traversing electromagnetic radiation within the array, with the irregularity positioned between the channels, producing a channel drop filter.

39. The method of claim 38, wherein the channels are optical channels.

40. The method of claim 38, wherein the channels are substantially parallel.

41. The method of claim 21, wherein a plurality of irregularities is provided in the array in the form of a periodic line of that serves as a dispersive waveguide.

42. The method of claim 41, wherein the irregularity comprises two elements in the form of two parts of a split cylinder kept at a predetermined distance.

43. The method of claim 42, wherein the predetermined distance is adjustable.

44-45. (canceled)
